(19) United States
(12) Patent Application Publication
(10) Pub. No.: US 2017/0367541 A1
(43) Pub. Date: Dec. 28, 2017

(54) Infant Bath Aide

(71) Applicant: Patricia DETLOR, Frankford (CA)

(72) Inventor: Patricia DETLOR, Frankford (CA)

(21) Appl. No.: 15/194,322

(22) Filed: Jun. 27, 2016

(51) Int. Cl. A47K 3/12; F16B 47/00; A47C 27/08

(52) U.S. Cl. CPC A47K 3/127; A47C 27/081; F16B 47/00

(57) ABSTRACT

An inflatable waterproof bath aide comprising an inflated vinyl mattress having a central bed chamber, an elevated pillow chamber, elevated left and right chambers, an air inflation valve on its lower face, and a plurality of suction cups on its lower face for attachment to a bathing surface.

### FIELD OF THE INVENTION

The present invention relates to infant care. In particular, the present invention relates to devices for safely bathing infants.

### BACKGROUND OF THE INVENTION

It is known in the prior art to provide various devices which are designed to increase the safety, convenience or comfort of bathing an infant.

Such prior art devices include rigid small bathing containers which may be placed inside a larger bathtub or sink to support the infant while permitting containment of water leaving the bathing container. Other such devices include seating devices which brace the infant in a semi-upright position within the larger tub or sink.

Navarra, in U.S. Pat. No. 3,931,652 teaches an inflatable container with pillow which snugly lines a sink to provide extensive padding for preventing injury while bathing an infant. Some prior art devices include suction cup means for securing the device to the base of the tub or sink.

None of the prior art provides, in one lightweight, low cost device, padding support for comfort and safety; means to elevate an infant's head above the bath water; means for securing the device to the base of a sink or tub; and barrier means to contain the infant within the device.

As will be described below, the infant bath aide device of the present invention provides all of these features.

### BRIEF DESCRIPTION OF THE DRAWINGS

A detailed description of the preferred embodiments is provided by way of example only and with reference to the following drawings, in which:

FIG. 1 is a top plan view of a preferred embodiment of the present invention; and

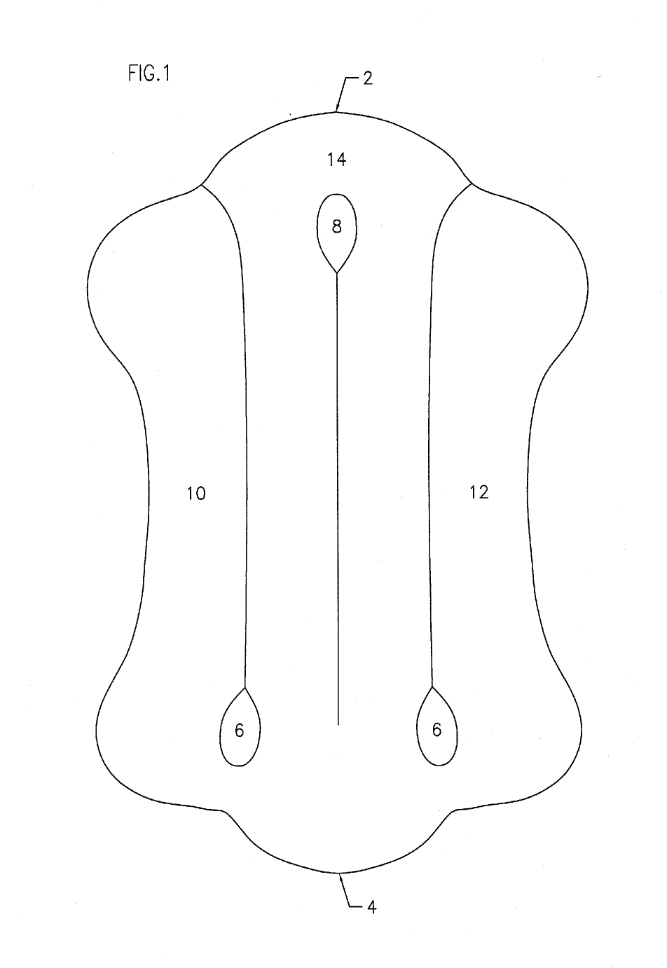

FIG. 2 is a bottom plan view of a preferred embodiment of the present invention.

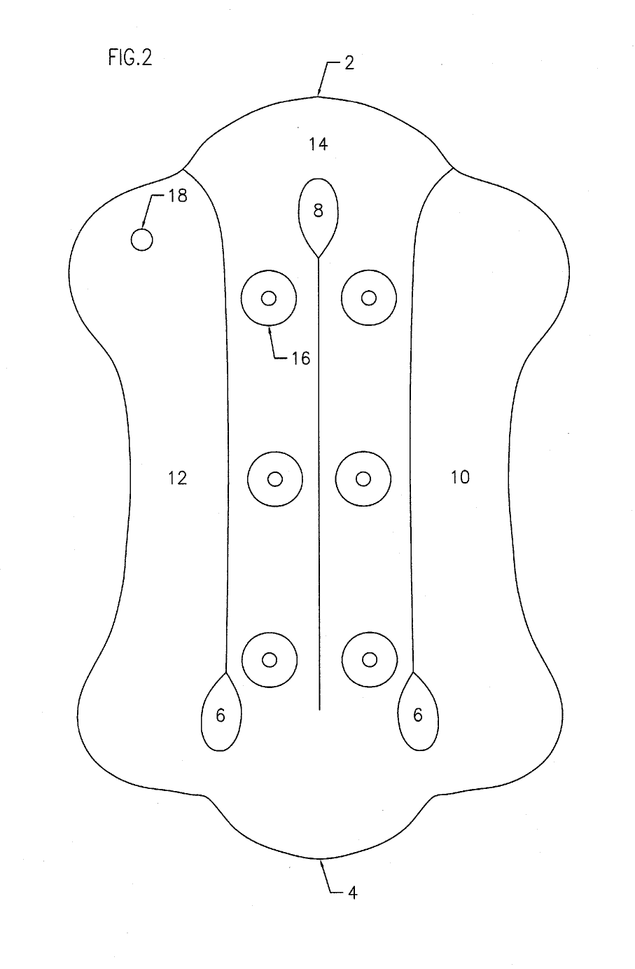

In the drawings, one embodiment of the invention is illustrated by way of example. It is to be expressly understood that the description and drawings are only for the purpose of illustration and as an aid to understanding, and are not intended as a definition of the limits of the invention.

### SUMMARY OF THE INVENTION

There is provided an inflatable waterproof infant bath aide comprising two layers of vinyl heat-sealed along their entire perimeter, each layer having a generally rectangular shape with a rounded head end and a rounded foot end; wherein the layers are further heat-sealed along three parallel internal seams; a first medial seam extending from a first end in proximity to the foot end of the vinyl layers to a second end in proximity to the head end of the vinyl layers, the second end of the medial seam forming a heat-sealed patch in the shape of a tear drop; a left lateral seam positioned equidistant from the left side of the vinyl layers and the medial seam, the left lateral seam extending from a first end at the edge of the head end of the vinyl layers to a second end in proximity to the foot end of the vinyl layers, the second end of the left lateral seam forming a heat-sealed patch in the shape of a tear drop; a right lateral seam positioned equidistant from the right side of the vinyl layers and the medial seam, the right lateral seam extending from a first end at the edge of the head end of the vinyl layers to a second end in proximity to the foot end of the vinyl layers, the second end of the right lateral seam forming a heat-sealed patch in the shape of a tear drop; and an air valve inserted through one vinyl layer to permit manual inflation.

There may be one or more suction cups attached to one vinyl layer, and the one or more suction cups may be attached to one vinyl layer between the left and right lateral seams. Preferably there will be six suction cups.

In another of its aspects, the invention comprises an inflatable waterproof bath aide comprising an inflated vinyl mattress having a central bed chamber, an elevated head section, elevated left and right chambers, an air inflation valve on its lower face, and a plurality of suction cups on its lower face for attachment to a bathing surface.

### DETAILED DESCRIPTION OF THE INVENTION

There is provided an infant bath aide device comprising two layers of vinyl cut into a generally ovoid shape having a head end 2 and a feet end 4. The layers of vinyl are heat sealed along their entire perimeter, as well as along three parallel longitudinal seams, a left seam, a middle seam, and a right seam.

At the feet end of each of the side seams is provided a heat sealed patch 6 which preferably is in a teardrop shape. The middle seam also includes a heat sealed patch 8 at the head end, and may have a heat sealed patch at its feet end. Each of the left and right seams diverge at the head end to extend to the perimeter.

The layered vinyl with heat sealing may be inflated to create distinct chambers within the infant bath aide. The left and right seams, by extending to the perimeter of the vinyl layers, create left and right side barrier chambers 10, 12 which become elevated relative to the central region along the middle seam. These barrier chambers serve to contain an infant within the bath aide device.

The divergent head ends of the left and right seams provide a widened elevated pillow chamber 14 at the head end for an infant. The heat sealed patch 8 at the head end of the middle seam functions to provide a flatter surface for the infant's head on the elevated pillow chamber. The heat sealed patches 6 at the feet end of the seams serves to provide a flatter area for the infant's feet.

In combination, the elevated side barriers, and elevated pillow area provide an inflated cradle within a bathtub or sink.

The bottom side of the infant bath aide may be provided with one or more suctions cups 16 for attachment of the bath aide device to the base of a bathtub or sink. Preferably, six 2-inch suction cups are dispersed evenly along the bottom side.

An air valve 18 of a type known for use with inflatable devices is provided preferably on the bottom side of the bath aide device.

Preferably, the top side of the bath aide device may be covered with terry cloth or other soft fabric for increased comfort for the infant.

In the preferred embodiment, as shown in the drawings, the bath aide device has a central width of 21 inches, with the distance between each edge and the corresponding side seam being 5 inches. The bath aide device may be flared at its feet end with the side barriers increasing to 5.75 inches wide. In proximity to the head end, the side marries may be 6 inches wide. The overall length along the middle of the bath aide device preferably is 28 inches. Other dimensions are also possible and are within the scope of the invention.

One advantage of the present invention is the ability to deflate the device for ease of transportation and storage.

Shapes other than that shown n the drawings are also possible, provided the side barrier chambers and pillow chamber are maintained. For example, the bath aide device may be in the shape of and decorated to represent an animal, a vehicle, a character, or otherwise to appeal to an infant.

Although vinyl is the preferred materials for the inflatable infant bath aide device due to its waterproofing and durability features, other waterproof and durable materials may also be used.

In this description, the term “infant” includes baby, toddler, and child.

It will be appreciated by those skilled in the art that other variations of the preferred embodiment may also be practiced without departing from the scope of the invention.

1. An inflatable waterproof infant bath aide comprising:
a. two layers of vinyl heat-sealed along their entire perimeter, each layer having a generally ovoid shape with a rounded head end and a rounded feet end; wherein the layers are further heat-sealed along three parallel internal seams;
i. a first medial seam extending from a first end in proximity to the feet end of the vinyl layers to a second end in proximity to the head end of the vinyl layers, the second end of the medial seam forming a heat-sealed patch in the shape of a tear drop;
ii. a left side seam positioned equidistant from the left side of the vinyl layers and the medial seam, the left side seam extending from a first end at the edge of the head end of the vinyl layers to a second end in proximity to the feet end of the vinyl layers, the second end of the left side seam forming a heat-sealed patch in the shape of a tear drop;
iii. a right side seam positioned equidistant from the right side of the vinyl layers and the medial seam, the right side seam extending from a first end at the edge of the head end of the vinyl layers to a second end in proximity to the feet end of the vinyl layers, the second end of the right side seam forming a heat-sealed patch in the shape of a tear drop; and
b. an air valve inserted through one vinyl layer to permit manual inflation.

2. The inflatable bath aide of claim 1, further comprising one or more suction cups attached to one vinyl layer.

3. The inflatable bath aide of claim 2, wherein the one or more suction cups are attached to one vinyl layer between the left and right side seams.

4. The inflatable bath aide of claim 3, wherein the one or more suction cups comprise six suction cups.

5. An inflatable waterproof bath aide comprising an inflated vinyl mattress having a central bed chamber, an elevated pillow chamber, elevated left and right chambers, an air inflation valve on its lower face, and a plurality of suction cups on its lower face for attachment to a bathing surface.
